(19) United States
(12) Patent Application Publication
(10) Pub. No.: US 2012/0011119 A1
(43) Pub. Date: Jan. 12, 2012

(54) OBJECT RECOGNITION SYSTEM WITH DATABASE PRUNING AND QUERYING

(75) Inventors: Pawan K. Baheti, San Diego, CA (US); Ashwin Swaminathan, San Diego, CA (US); Serafin Diaz Spindola, San Diego, CA (US); Xia Ning, Minneapolis, MN (US)

(73) Assignee: QUALCOMM Incorporated, San Diego, CA (US)

(21) Appl. No.: 12/832,796

(22) Filed: Jul. 8, 2010

(51) Int. Cl. G06F 17/30

(52) U.S. Cl. 707/737; 707/780; 707/E17.089; 707/E17.014

(57) ABSTRACT

A database for object recognition is generated by performing at least one of intra-object pruning and inter-object pruning, as well as keypoint clustering and selection. Intra-object pruning removes similar and redundant keypoints within an object and different views of the same object, and may be used to generate and associate a significance value, such as a weight, with respect to remaining keypoint descriptors. Inter-object pruning retains the most informative set of descriptors across different objects, by characterizing the discriminability of the keypoint descriptors for all of the objects and removing keypoint descriptors with a discriminability that is less than a threshold. Additionally, a mobile platform may download a geographically relevant portion of the database and perform object recognition by extracting features from the query image and using determined confidence levels for each query feature during outlier removal.

### BACKGROUND

Augmented reality (AR) involves superposing information directly onto a camera view of real world objects. Recently there has been tremendous interest in developing AR type applications for mobile applications, such as a mobile phone. One type of AR application that is of interest is vision-based AR, i.e., processing the pixels in the camera (view) frames to both detect and track points of interest (POI) to the user.

Vision-based AR uses object detection that involves not only the recognition (or not) of a reference object in the query image captured by camera but also computing the underlying spatial transformation of the object between reference and query. One important consideration in the design of a vision-based AR system is the size and composition of the database (DB) of features derived from images of reference objects. Another important consideration is the query process in which the descriptions of query features are matched against those of reference images.

### SUMMARY

A database for object recognition is generated by performing at least one of intra-object pruning and inter-object pruning, as well as keypoint clustering and selection. Intra-object pruning removes similar and redundant keypoints within an object and different views of the same object, and may be used to generate and associate a significance value, such as a weight, with respect to remaining keypoint descriptors. Inter-object pruning retains the most informative set of descriptors across different objects, by characterizing the discriminability of the keypoint descriptors for all of the objects and removing keypoint descriptors with a discriminability that is less than a threshold.

A match between a query image and information related to images of objects stored in a database is performed by retrieving nearest neighbors from the database and determining the quality of the match for the retrieved neighbors. The quality of the match is used to generate an object candidate set, which is used to remove outliers. A confidence level for each query feature may also be used to remove outliers. The search maybe performed on a mobile platform, which downloads a geographically relevant portion of the database from a central server.

### BRIEF DESCRIPTION OF THE DRAWING

FIG. 1 illustrates an example of a mobile platform that includes a camera and is capable of capturing images of objects that are identified by comparison to a feature database.

FIG. 2 illustrates a block diagram showing a system in which an image captured by a mobile platform is identified by comparison to a feature database.

FIG. 3 is a block diagram of offline server based processing to generate a pruned database.

FIG. 4 illustrates generating a pruned database by pruning features extracted from reference objects and their views.

FIG. 5 is a block diagram of a server that is capable of pruning a database.

FIG. 6 is a flowchart illustrating an example of intra-object pruning

FIG. 7 is a flowchart illustrating an example of inter-object pruning

FIG. 8 is a flowchart illustrating an example of location based pruning and keypoint clustering.

FIGS. 9A and 9B illustrate the respective results of intra-object pruning, inter-object pruning, and location based pruning and keypoint clustering for one object.

FIGS. 10A and 10B are similar to FIGS. 9A and 9B, but show a different view of the same object.

FIG. 11 illustrates mobile platform processing to match a query image to an object in a database.

FIGS. 12A and 12B are a block diagram and corresponding flow chart illustrating the query process with extracted feature matching and confidence level generation and outlier removal.

FIG. 13 is a block diagram of the mobile platform that is capable of capturing images of objects that are identified by comparison to information related to objects and their views in a database.

FIG. 14 is a graph illustrating the recognition rate for the ZuBud query images for different sized databases.

FIG. 15 is a graph illustrating the recognition rate with respect to the distance threshold used for retrieval in FIG. 14.

### DETAILED DESCRIPTION

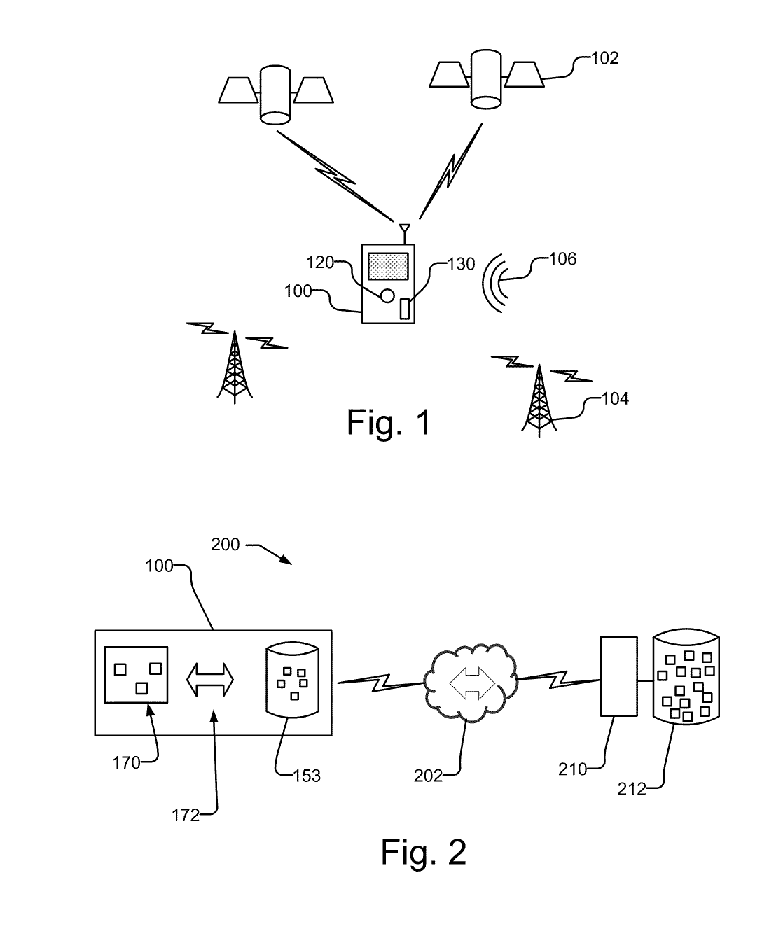

FIG. 1 illustrates an example of a mobile platform 100 that includes a camera 120 and is capable of capturing images of objects that are identified by comparison to a feature database. The feature database includes, e.g., images as well as features, such as descriptors extracted from the images, along with information such as object identifiers, view identifiers and location. The mobile platform 100 may include a display to show images captured by the camera 120. The mobile platform 100 may be used for navigation based on, e.g., determining its latitude and longitude using signals from a satellite positioning system (SPS), which includes satellite vehicles 102, or any other appropriate source for determining position including cellular towers 104 or wireless communication access points 106. The mobile platform 100 may also include orientation sensors 130, such as a digital compass, accelerometers or gyroscopes, that can be used to determine the orientation of the mobile platform 100.

As used herein, a mobile platform refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile platform” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile platform” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile platform.”

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs) 102, illustrated in FIG. 1. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile platform 100 is not limited to use with an SPS for position determination, as position determination techniques described herein may be implemented in conjunction with various wireless communication networks, including cellular towers 104 and from wireless communication access points 106, such as a wireless wide area network (WWAN), a wireless local area network (WLAN), a wireless personal area network (WPAN). Further the mobile platform 100 may access one or more servers to obtain data, such as reference images and reference features from a database, using various wireless communication networks via cellular towers 104 and from wireless communication access points 106, or using satellite vehicles 102 if desired. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

FIG. 2 illustrates a block diagram showing a system 200 in which an image captured by a mobile platform 100 is identified by comparison to a feature database. As illustrated, the mobile platform 100 may access a network 202, such as a wireless wide area network (WWAN), e.g., via cellular tower 104 or wireless communication access point 106, illustrated in FIG. 1, which is coupled to a server 210, which is connected to a database 212 that stores information related to objects and their images. While FIG. 2 shows one server 210, it should be understood that multiple servers may be used, as well as multiple databases 212. The mobile platform 100 may perform the object detection itself, as illustrated in FIG. 2, by obtaining at least a portion of the database from server 210 and storing the downloaded data in a local database 153 in the mobile platform 100. The portion of a database obtained from server 210 is based on the mobile platform's geographic location as determined by the mobile platform's positioning system. Moreover, the portion of the database obtained from server 210 may depend upon the particular application that requires the database on the mobile platform 100. The mobile platform 100 may extract features from a captured query image (illustrated by block 170), and match the query features to features that are stored in the local database 153 (as illustrated by double arrow 172). The query image may be an image in the preview frame from the camera or an image captured by the camera, or a frame extracted from a video sequence. The object detection may be based, at least in part, on determined confidence levels for each query feature, which can then be used in outlier removal. By downloading a small portion of the database 212 based on the mobile platform's geographic location and performing the object detection on the mobile platform 100, network latency issues are avoided and the over the air (OTA) bandwidth usage is reduced along with memory requirements on the client (i.e., mobile platform) side. If desired, however, the object detection may be performed by the server 210 (or other server), where either the query image itself or the extracted features from the query image are provided to the server 210 by the mobile platform 100.

Additionally, because the database 212 may include objects that are captured in multiple views, and, additionally, each object may possess local features that are similar to features found in other objects, it is desirable that the database 212 is pruned to retain only the most distinctive features and, as a consequence, a representative minimal set of features to reduce storage requirements while improving recognition performance or at least not harming recognition performance. For example, an image in VGA resolution (640 pixels×480 pixels) that undergoes conventional Scale Invariant Feature Transform (SIFT) processing would result in around 2500 d-dimensional SIFT features with d≈128. Assuming 2 bytes per feature element, storage of the SIFT features from one image in VGA resolution would require approximately 2500×128×2 bytes or 625 Kb of memory. Accordingly, even with a limited set of objects, the storage requirements may be large. For example, the ZuBud database has only 201 unique POI building objects with five views per object, resulting in a total of 1005 images and a memory requirement that is in the order of 100s of Mega bytes. It is desirable to reduce the number of features stored in the database, particularly where a local database 153 will be stored on the client side, i.e., mobile platform 100.

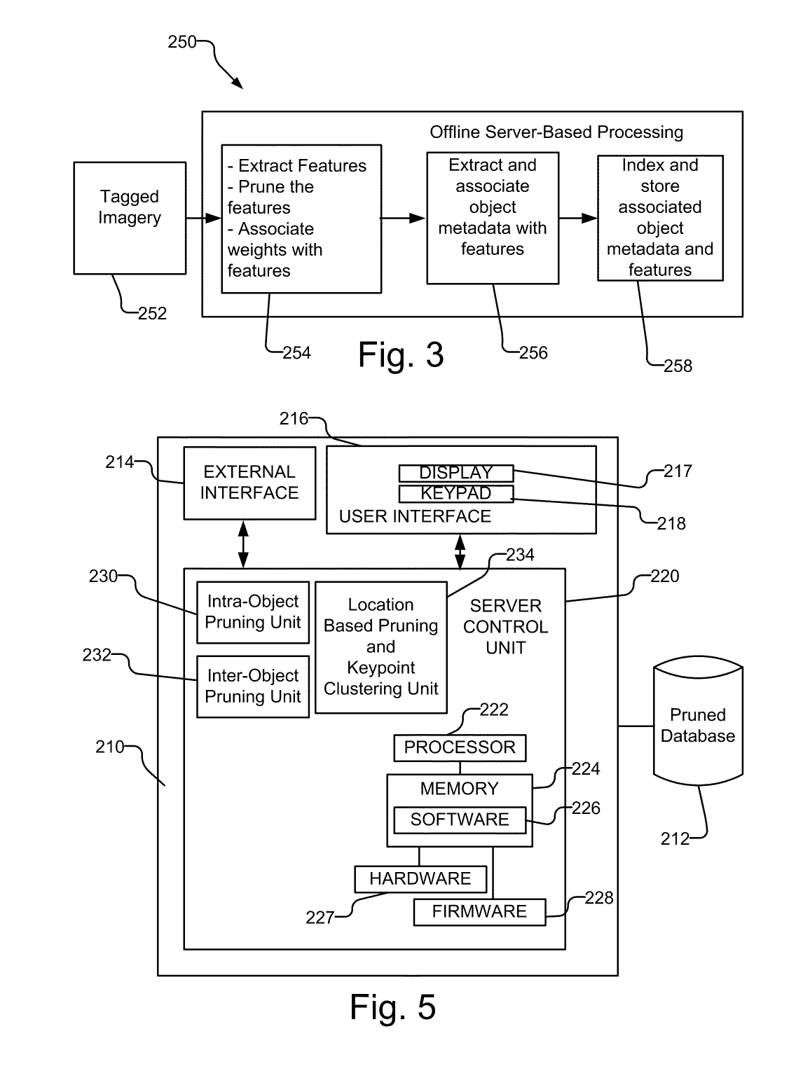

FIG. 3 is a block diagram of offline server based processing 250 to generate a pruned database 212. As illustrated, imagery 252 is provided to be processed. The imagery 252 may be tagged with information for identification, for example, imagery 252 may be geo-tagged. The geo-tagging of imagery 252 is advantageous as it serves as an attribute in a hierarchical organization of the reference data stored in the feature database 212 and also permits the mobile platform 100 to download a relatively small portion of the feature database based on geographic location. The tagged imagery 252 may be uploaded as a set of images to the server 210 (or a plurality of servers) during the creation of the database 212 as well as uploaded individually by a mobile platform 100, e.g., to update the database 212 when it is determined that a query image has no matches in the database.

The tagged imagery 252 is processed by extracting features from the geo-tagged imagery, pruning the features in the database, as well as determining and assigning a significance for the features, e.g., in the form of a weight (254). The extracted features are to provide a recognition-specific representation of the images, which can be used later for comparison or matching to features from a query image. The representation of the images should be robust and invariant to a variety of imaging conditions and transformations, such as geometric deformations (e.g., rotations, scale, translations etc.), filtering operations due to motion blur, bad optics etc., as well as variations in illuminations, and changes in pose. Such robustness cannot be achieved by comparing the image pixel values and thus, an intermediate representation of image content that carries the information necessary for interpretation is used. Features may be extracted using a well known technique, such as Scale Invariant Feature Transform (SIFT), which localizes features and generates their descriptions. If desired, other techniques, such as Speed Up Robust Features (SURF), Gradient Location-Orientation Histogram (GLOH), Compressed Histogram of Gradients (CHoG) or other comparable techniques may be used. Extracted features are sometimes referred to herein as keypoints, which may include feature location, scale and orientation when SIFT is used, and the descriptions of the features are sometimes referred to herein as keypoint descriptors or simply descriptors. The extracted features may be compressed either before pruning the database or after pruning the database. Compressing the features may be performed by exploiting the redundancies that may be present along the features dimensions, e.g., using principal component analysis to reduce the descriptor dimensionality from N to D, where D<N, such as from 128 to 32. Other techniques may be used for compressing the features, such as entropy coding based methods. Additionally, object metadata for the reference objects, such as geo-location or identification, is extracted and associated with the features (256) and the object metadata and associated features are indexed and stored in the database 212 (258).

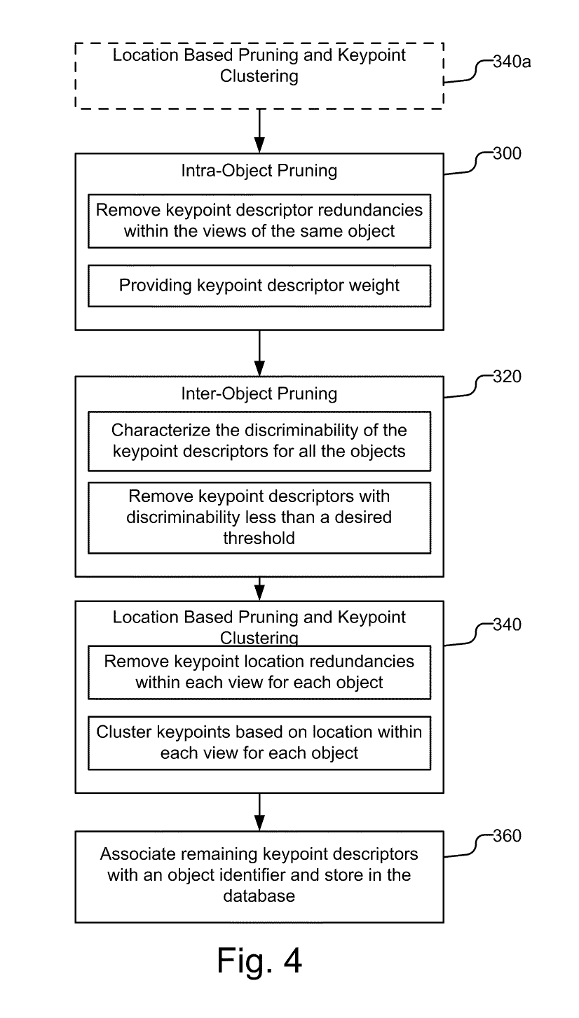

FIG. 4 illustrates generating the pruned database 212 by pruning features extracted from reference objects and their views to reduce the amount of memory required to store the features. The process includes intra-object pruning (300), inter-object pruning (320), and location based pruning and keypoint clustering (340). Intra-object pruning (300) removes similar and redundant keypoints within an object and different views of the same object, retaining a reduced number of keypoints, e.g., one keypoint, in place of the redundant keypoints. Additionally, the remaining keypoint descriptors are provided with significance, such as a weight, which may be used in additional pruning, as well as in the object detection. Intra-object pruning (300) improvise object recognition accuracy by helping to select only a limited number of keypoints that best represent a given object.

Inter-object pruning (320) is used to retain the most informative set of descriptors across different objects, by characterizing the discriminability of the keypoint descriptors for all of the objects and removing keypoint descriptors with a discriminability that is less than a threshold. Inter-object pruning (320) helps improve classification performance and confidence by discarding keypoints in the database that appear in several different objects.

Location based pruning and keypoint clustering (340) is used to help ensure that the final set of pruned descriptors have good information content and provide good matches across a range of scales. Location based pruning removes keypoint location redundancies within each view for each object. Additionally, keypoints are clustered based on location within each view for each object and a predetermined number of keypoints within each cluster is retained. The location based pruning and/or keypoint clustering (340) may be performed after the inter-object pruning (320), followed by associating the remaining keypoint descriptors with objects and storing in the database 212. If desired, however, as illustrated with the broken lines in FIG. 4, the location based pruning and keypoint clustering (340a) can be performed before intra-object pruning (300), in which case, associating the remaining keypoint descriptors with objects (360) and storing in the database 212 may be performed after the inter-object pruning (320).

Additionally, if desired, the database 212 may be pruned using only one of the intra-object pruning, e.g., where the data is limited in the number of reference objects it contains, or the inter-object pruning.

FIG. 5 is a block diagram of a server 210 that is coupled to the pruned database 212. The server 210 may process imagery to generate the data stored in the pruned keypoint database 212 and provide at least a portion of the pruned database to the mobile platform 100 as illustrated in FIG. 2. While FIG. 5 illustrates a single server 210, it should be understood that multiple servers communicating over external interface 214 may be used. The server 210 includes an external interface 214 for receiving imagery to be processed and stored in the database 212. The external interface 214 may also communicate with the mobile platform 100 via network 202 and through which geo-tagged imagery may be provided to the server 210. The external interface 214 may be a wired communication interface, e.g., for sending and receiving signals via Ethernet or any other wired format. Alternatively, if desired, the external interface 214 may be a wireless interface. The server 210 further includes a user interface 216 that includes, e.g., a display 217 and a keypad 218 or other input device through which the user can input information into the server 210. The server 210 is coupled to the pruned database 212.

The server 210 includes a server control unit 220 that is connected to and communicates with the external interface 214 and the user interface 216. The server control unit 220 accepts and processes data from the external interface 214 and the user interface 216 and controls the operation of those devices. The server control unit 220 may be provided by a processor 222 and associated memory 224, software 226, as well as hardware 227 and firmware 228 if desired. The server control unit 220 includes a intra-object pruning unit 230, an inter-object pruning unit 232 and a location based pruning and keypoint clustering unit 234, which may be are illustrated as separate from the processor 222 for clarity, but may be within the processor 222. It will be understood as used herein that the processor 222 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The methodologies described herein may be implemented by various means depending upon the application. For example, these methodologies may be implemented in software 226, hardware 227, firmware 228 or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 224 and executed by the processor 222. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

For example, software 226 codes may be stored in memory 224 and executed by the processor 222 and may be used to run the processor and to control the operation of the mobile platform 100 as described herein. A program code stored in a computer-readable medium, such as memory 224, may include program code to extract keypoints and generate keypoint descriptors from a plurality of images and to perform intra-object and/or inter-object pruning as described herein, as well as program code to cluster keypoints in each image based on location and retain a subset of keypoints in each cluster of keypoints; program code to associate remaining keypoints with an object identifier; and program code to store the associated remaining keypoints and object identifier in the database.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The server 210 prunes the database by at least one of intra-object pruning, inter-object pruning as well as location based pruning and/or keypoint clustering. The server may employ an information-theoretic approach or a distance comparison approach for database pruning. The distance comparison approach may be based on, e.g., Euclidean distance comparisons. The information-theoretic approach to database pruning models keypoint distribution probabilities to quantify how informative a particular descriptor is with respect to the objects in the given database. Before describing database pruning by server 210, it is useful to briefly review the mathematical notations to be used. Let M denote the number of unique objects, i.e., points of interest (POI), in the database. Let the number of image views for the i^{th} object be denoted by Nᵢ. Let the total number of descriptors across the Nᵢ, views of the i^{th} object be denoted by Kᵢ. Let f_{i,j} represent the j^{th} descriptor for the i^{th} object, where j=1 . . . Kᵢ and i=1 . . . M. Let the set Sᵢ contain the Kᵢ descriptors for the i^{th} object such that sᵢε{f_{i,j}; j=Kᵢ}. By pruning the database, the cardinality of the descriptor sets per object are significantly reduced but maintain high recognition accuracy.

In the information-theoretic approach to database pruning, a source variable X is defined as taking integer values from 1 to M, where X=i indicates that the i^{th} object from the database was selected. Let the probability of X selecting the i^{th} object be denoted by pr (X=i). Recall that the set Sᵢ contain the Kᵢ descriptors for the i^{th} object such that Sᵢε{f_{i,j}; j=1 . . . Kᵢ}. Let \tilde{S}ᵢ represent the pruned descriptor set for the i^{th} object. The pruning criterion can then be stated as:

max_{\tilde{S}}[/(I(X;\tilde{S})] such that |\tilde{S}ᵢ|=|\tilde{K}ᵢ|,

where \tilde{S}={\tilde{S}₁ . . . \tilde{S}_{M}} and i=1 . . . M. eq. 1

The term I(X;\tilde{S}) represents the mutual information between X and \tilde{S}. The term \tilde{K}ᵢ denotes the desired cardinality of the pruned set \tilde{S}. In other words, to form the pruned database, it is desired to retain the descriptors from the original database that maximize the mutual information between X and the pruned database \tilde{S}. With such a criterion, features that are less informative about the occurrence of a database object in the input image may be eliminated. It is noted that maximization is prohibitive because it involves the joint and conditional distribution of descriptors given the entire database and is computationally expensive even for small M, Kᵢ. Accordingly, it may be assumed that each descriptor is a statistically independent event, which implies that the mutual information in eq. 1 can be expressed as:

$$I ( X ; \tilde{S} ) = {\sum }_{{f}_{i , j} ∈ \tilde{S}} I ( X ; {f}_{i , j} ) . \qquad eq . 2$$

With the assumption of statistical independence of individual descriptors, the mutual information I(X;\tilde{S}) is expressed as the summation of the mutual information provided by individual descriptors in the pruned set. Maximizing the individual mutual information component I(X; f_{i,j}) in eq. 2 is equivalent to minimizing the conditional entropy H [symbol] (X|f_{i,j} [symbol] which is a measure of randomness about the source variable X given the descriptor f_{i,j}. Therefore, lower conditional entropy for a particular descriptor implies that it is statistically more informative. The conditional entropy H [symbol] X|f_{i,j} [symbol] is given as:

$$H 〈 X \vert {f}_{i , j} 〉 = - {\sum }_{k = 1}^{M} p 〈 X = k \vert {f}_{i , j} 〉 log p 〈 X = k \vert {f}_{i , j} 〉 , \qquad eq . 3$$

where p [symbol] X=k|f_{i,j} [symbol] is the conditional probability of the source variable X equal to the k^{th} object given the occurrence of descriptor f_{i,j}(i=1 . . . M and j=1 . . . Kᵢ). In a perfectly deterministic case, where the occurrence of a particular descriptor f_{i,j} is associated with only one object in the database, the conditional entropy goes to 0; whereas, if a specific descriptor is equally likely to appear in all the M database objects then the conditional entropy is highest and is equal to log₂M bits (assuming all objects are equally likely i.e., pr (X=k)=1/M. It is to be noted that selection of features based on the criteria that H [symbol] X|f_{i,j} [symbol] <γ, where γ is set to, e.g., 1 bit, fails to consider keypoint properties such as scale and location in the section of the pruned descriptor set. Moreover, additional information may be imparted into the feature selection by associating a weighting factor to each descriptor, denoted by w_{i,j}, and initialized to =1/Kᵢ, where j=1 . . . Kᵢ.

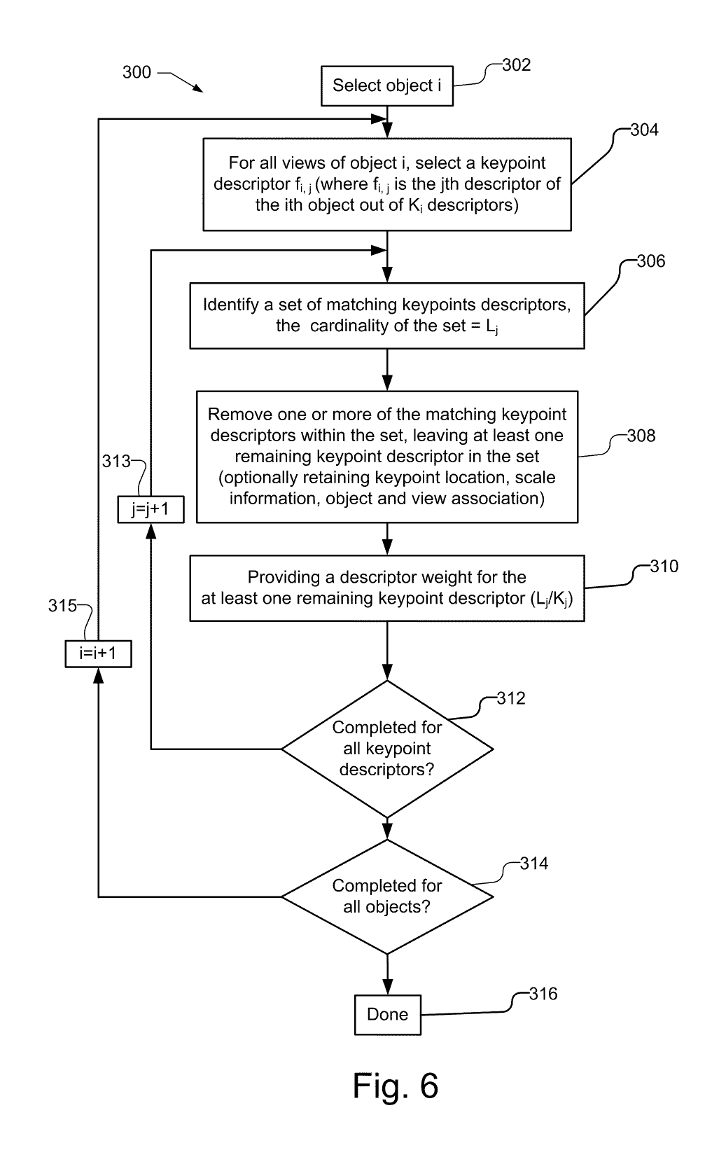

FIG. 6 is a flowchart illustrating an example of intra-object pruning (300), which may be used with the information-theoretic approach to prune the database. As discussed above, the intra-object pruning (300) removes descriptor redundancies within the views of the same object. As illustrated in FIG. 6, the i^{th} object is selected (302) and for all views of the i^{th} object, a keypoint descriptor f_{i,j} is selected (304). A set of matching keypoint descriptors are identified (306). Matching keypoint descriptors may be identified based on a similarity metric, e.g., such as distance, distance ratio, etc. For example, distance may be used where any two keypoint descriptors f_{i,j} and f_{i,m} (where l, m=1 . . . K₁) are determined to be a match if the Euclidean distance between the features is less than a threshold, i.e., ∥f_{i,j}-f_{i,m}∥_{L}_{₂}<τ. The cardinality of the set of matching keypoint descriptors is Lⱼ.

One or more of the matching keypoint descriptors within the set is removed leaving one or more keypoint descriptors (308), which helps retain the most significant keypoints that are related to the object for object detection. For example, the matching keypoint descriptors may be compounded into a single keypoint descriptor, e.g., by averaging or otherwise combining the keypoint descriptors, and all of the matching keypoint descriptors in the set may be removed. Thus, where the matching keypoint descriptors are compounded, the remaining keypoint descriptor is a new keypoint descriptor that is not from the set of matching keypoint descriptors. Alternatively, one or more keypoint descriptors from the set of matching keypoint descriptors may be retained, while the remainder of the set is removed. The one or more keypoint descriptors to be retained may be selected based on the dominant scale, the view that the keypoint belong to (e.g., it may be desired to retain the keypoints from a front view of the object), or it may be selected randomly. If desired, the keypoint location, scale information, object and view association of the remained keypoint descriptors may be retained which may be used for geometry consistency tests during outlier removal.

The significance of keypoint descriptors is determined and assigned to each remaining keypoint descriptor. For example, a weight may be determined and assigned to the one or more remaining keypoint descriptors (310). Where only one keypoint descriptor remains, the provided descriptor weight w_{i,j} may be based on the number of matching keypoint descriptors in the set (Lⱼ) with respect to the total number of possible keypoint descriptors (Kⱼ), e.g., w_{i,j}=Lⱼ/Kᵢ.

If there are additional keypoint descriptors for the i^{th} object (312), the next keypoint descriptor is selected (313) and the process returns to block 306. When all of the keypoint descriptors for the i^{th} object are completed, it is determined whether there are additional objects (314). If there are more objects, the next object is selected (315) and the process returns to block 304, otherwise, the intra-object pruning is finished (316).

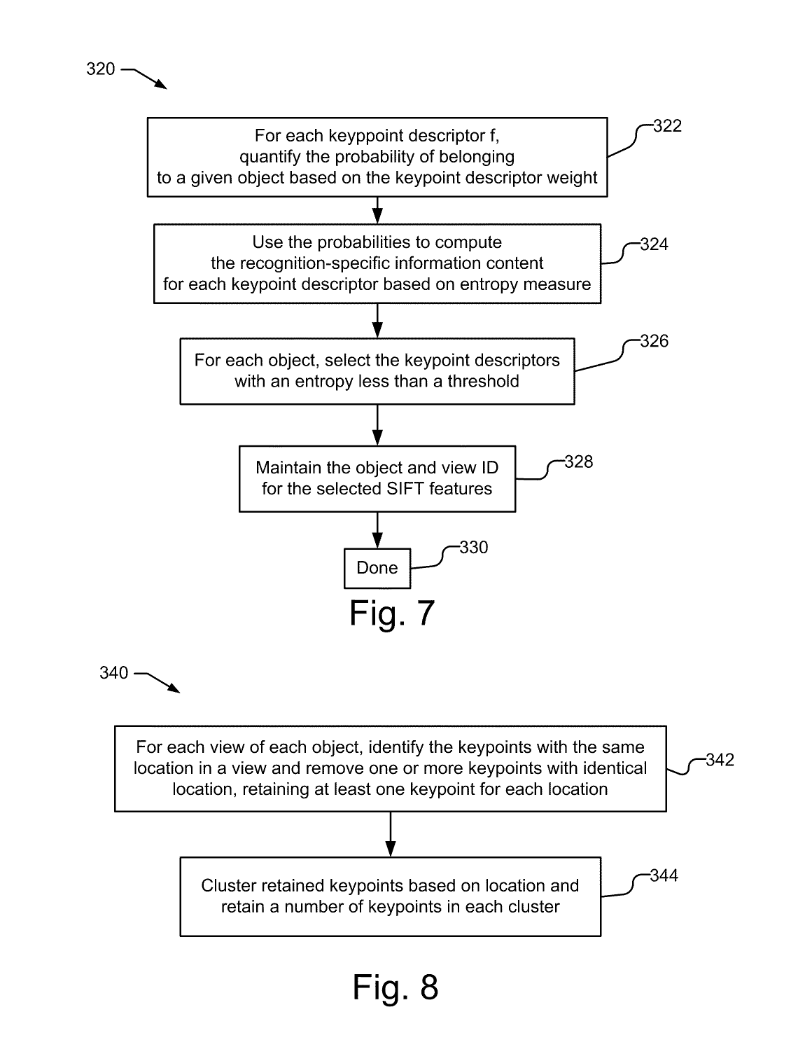

FIG. 7 is a flowchart illustrating an example of inter-object pruning (320), which may be used with the information-theoretic approach to pruning the database. Inter-object pruning (320) eliminates keypoints that repeat across multiple objects that might otherwise hinder object detection. For instance, suppose in the database there have two objects, i₁ and i₂, and parts of object i₁ are repeated in object i₂. In such a scenario, the features extracted from the common parts have the effect of confusing classification for object detection (and reducing the confidence score in classification). Such features, which may be good for object representation, could reduce the classification accuracies and are therefore desirable to eliminate. As illustrated in FIG. 7, for each keypoint descriptor f, the probability of belonging to a given object p [symbol] f|X=k [symbol] is quantified (322). The probability may be based on the keypoint descriptor weight.

The probability of belonging to a given object may be quantified for each descriptor f=f_{i,j} (i=1 . . . M; j=1 . . . Kᵢ) in the database as follows. The nearest neighbors are retrieved from the descriptor database of the keypoint descriptors remaining after intra-object pruning. The nearest neighbors may be retrieved using a search tree, e.g., using Fast Library for Approximate Nearest Neighbor (FLANN), and are retrieved based on an L₂ (norm) less than a predetermined distance ε. The nearest neighbors are binned with respect to the object ID and may be denoted by f_{k,n} where k is the object ID and n is the nearest neighbor index. The nearest neighbors are used to compute the conditional probabilities p [symbol] (f=f_{i,j}|X=k [symbol] where k=1 . . . M. A mixture of Gaussians may be used to model the conditional probability and is provided as:

$$p 〈 f = {f}_{i , j} \vert X = k 〉 = {\sum }_{n} {w}_{{f}_{k , n}} G [ ( {f}_{i , j} - {f}_{k , n} ) ] , \\ where , G [ y ] = exp ( - \frac{{‖ y ‖}_{{L}_{2}}^{2}}{2 {σ}^{2}} ) and σ = ɛ / 2. \qquad eq . 4$$

The probability of belonging to a given object is then used to compute the recognition-specific information content for each keypoint descriptor (324). The recognition-specific information content for each keypoint descriptor may be computed by determining as the posterior probability p [symbol] X=k|f=f_{i,j} [symbol] using Bayes rule as follows:

$$p 〈 X = k \vert f = {f}_{i , j} 〉 = \frac{p 〈 f = {f}_{i , j} \vert X = k 〉 \cdot pr ( X = k )}{{\sum }_{l = 1}^{M} p 〈 f = {f}_{i , j} \vert X = l 〉 \cdot pr ( X = l )} . \qquad eq . 5$$

The posterior probability can then be used to compute the conditional entropy H [symbol] X|f_{i,j} [symbol] for an object, given a specific descriptor as described in eq. 3 above. The lower the conditional entropy for a particular descriptor implies that it is statistically more informative. Thus, for each object, keypoint descriptors are selected where the entropy is less than a predetermined threshold, i.e., H [symbol] X|f_{i,j} [symbol] <γ bits and the remainder of the keypoint descriptors are removed (326). The object and view identification is maintained for the selected keypoint descriptors (328) and the inter-object pruning is finished (330). For example, for indexing purposes and geometric verification purposes (post descriptor matching), the object and view identification may be tagged with the selected feature descriptor in the pruned database.

FIG. 8 is a flowchart illustrating an example of location based pruning and keypoint clustering (340), which may be used with the information-theoretic approach to pruning the database. For each view of each object, identify the keypoints with the same location in a view and remove one or more keypoints with the identical location (342). At least one keypoint is retained for each location. The one or more keypoints to be retained may be selected based on the largest scale or other keypoint descriptor property. The retained keypoints are then clustered based on their locations, e.g., forming k clusters, and for each cluster a number of keypoints kᵢ are selected to be retained and the remainder are removed (344). By way of example, 100 clusters may be formed and 5 keypoints from each cluster may be retained. The keypoints selected to be retained in each cluster may be based, e.g., on the largest scale, the pixel entropy around the keypoint location, i.e., the degree of randomness in the pixel region, or other keypoint descriptor property. Accordingly, the keypoint descriptors selected for each object view is less than k_{c}·kᵢ. The pruning of database 212 may be accomplished using only the keypoint clustering (344), without the location based pruning (342), if desired.

Using the information-theoretic approach to pruning the database as described

$$\frac{{\sum }_{i = 1}^{M} {K}_{i}}{( M \cdot {k}_{c} \cdot {k}_{l} )} .$$

above, the achievable database size reduction is lower bounded by
Besides database reduction, the information-optimal approach provides a formal framework to incrementally add or remove descriptors from the pruned set given feedback from a client mobile platform about recognition confidence level, or given system constraints, such as memory usage on the client, etc.

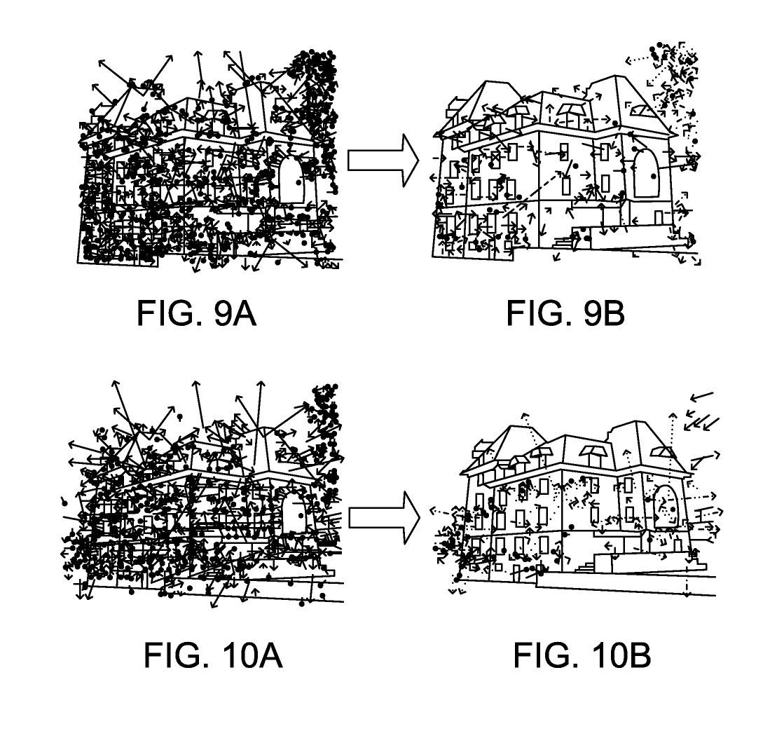

FIGS. 9A and 9B illustrate the respective results of intra-object pruning, inter-object pruning, and location based pruning and keypoint clustering for the above described information-theoretic approach to pruning the database for one object. FIGS. 10A and 10B are similar to FIGS. 9A and 9B, but show a different view of the same object. As can be seen in FIGS. 9B and 10B, the number of keypoint descriptors are substantially reduced and are spread out in geometric space in the images.

Using the information-optimal approach with the ZuBuD database, which has 201 objects and 5 views per object, from which approximately 1 million SIFT features were extracted, the feature dataset was reduced by approximately 8× to 40× based on a distance threshold of 0.4 for intra-object pruning and inter-object pruning and using 20 clusters (k_{c}) per database image view and 3 to 15 keypoints (kₗ) per cluster, without significantly reduced recognition accuracy.

As discussed above, the server 210 may employ a distance comparison approach to perform the database pruning, as opposed to the information-theoretic approach. The distance comparison approach, similarly uses intra-object pruning, inter-object pruning, and location based pruning and keypoint clustering, but as illustrated in FIG. 4, the location based pruning and keypoint clustering (340a) is performed before the intra-object pruning (300). Thus, as described in FIG. 8, the keypoints with the same location are pruned followed by clustering the remaining keypoints. An intra-object pruning process 300 is then performed as described in FIG. 6, where matching keypoint descriptors are compounded or one or more of the matching keypoint descriptors are retained, while the remainder of the keypoints descriptors are removed.

Inter-object pruning 320 may then be performed to eliminate the keypoints that repeat across multiple objects. As discussed above, it is desirable to remove repeating keypoint features across multiple objects that might otherwise confuse the classifier. The inter-object pruning, which may be used with the distance comparison approach to pruning the database, identifies keypoint descriptors, f_{i1, l}, and f_{i2, m} (where l=1 . . . Kₐ, m=1 . . . K₂), that do not belong to the same object, and checks to determine if the distance, e.g., Euclidean distance, between the features is less than a threshold, i.e., ∥f_{i2,l}-f_{i2,m}∥_{L}_{₂}<δ and discards them if they are less than the threshold. The remaining keypoint descriptors are then associated with the object identification from which it comes and stored in the pruned database.

Using the distance comparison approach with the ZuBuD database, which has 201 objects and 5 views per object, from which approximately 1 million SIFT features were extracted, the feature dataset was reduced by approximately 80% based on threshold values τδ=0.15. Using the pruned database as a reference database, 115 query images provided as part of ZuBuD, were tested and a 100% recognition accuracy was achieved. Thus, using this approach, the size of the SIFT keypoint database may be reduced by approximately 80% without sacrificing object recognition accuracies.

Referring back to FIG. 2, the detection of an object in a query image relative to information related to reference objects and their views in a database may be performed by the mobile platform 100, e.g., using a portion of the database 212 downloaded based on the mobile platform's geographic location. Alternatively, object detection may be performed on the server 210, or another server, where either the image itself or the extracted features from the image are provided to the server 210 by the mobile platform 100. Whether the object detection is performed by the mobile platform or server, the goal of object detection is to robustly recognize a query image as one of the objects in the database or to be able to declare that the query image is not present in the database. For the sake of brevity, object detection will be described as performed by the mobile platform 100.

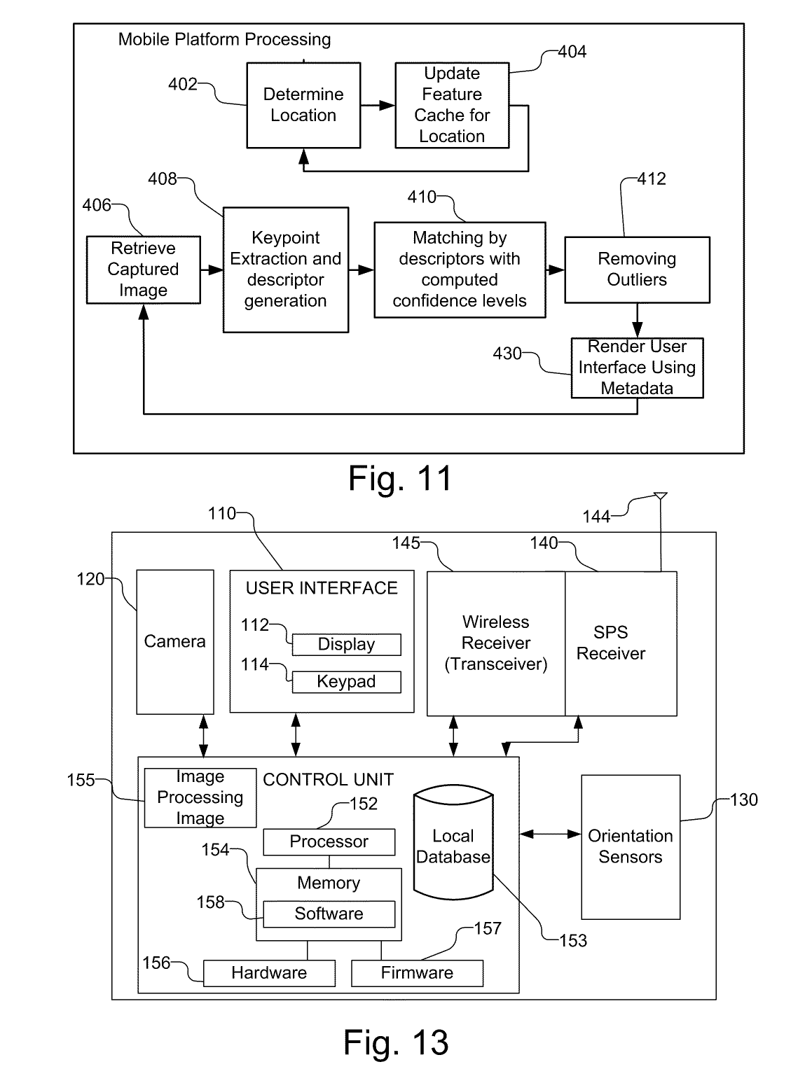

FIG. 11 illustrates mobile platform processing to match the query image to an object in the database. As illustrated, the mobile platform 100 determines its location (402) and updates the feature cache, i.e., local database, for location by downloading the geographically relevant portion of the database (404). The location of the mobile platform 100 maybe determined using, e.g., the SPS system including satellite vehicles 102 or various wireless communication networks, including cellular towers 104 and from wireless communication access points 106 as illustrated in FIG. 1. The database from which the mobile platform's local database is updated may be the pruned database 212 described above. The pruned database 212 may be similar to a raw database; but with the pruning techniques described herein, the pruned database 212 achieves a reduction in the database download size while maintaining equal or higher recognition accuracies compared to a raw database.

The mobile platform 100 retrieves an image captured by the camera 120 (406) and extracts features and generates their descriptors (408). As discussed above, features may be extracted using Scale Invariant Feature Transform (SIFT) or other well known techniques, such as Speed Up Robust Features (SURF), Gradient Location-Orientation Histogram (GLOH), or Compressed Histogram of Gradients (CHoG). In general, SIFT keypoint extraction and descriptor generation includes the following steps: a) the input color images are converted to gray scales and a Gaussian pyramid is built by repeated convolution of the grayscale image with Gaussian kernels with increasing scale, the resulting images form the scale-space representation, b) difference of Gaussian (also known as DoG) scale-space images is computed, and c) local extrema of the DoG scale-space images are computed and used to identify the candidate keypoint parameters (location and scale) in the original image space. The steps (a) to (c) are repeated for various upsampled and downsampled versions of the original image. For each candidate keypoint, an image patch around the point is extracted and the direction of its significant gradient is found. The patch is then rotated according to the dominant gradient orientation and keypoint descriptors are computed. The descriptor generation is done by 1) splitting the image patch around the keypoint location into D1×D2 regions, 2) bin the gradients into D3 orientation bins, and 3) vectorize the histogram values to form the descriptor of dimension D1·D2·D3. The traditional SIFT description uses D1=D2=4, and D3=8, resulting in 128-dimensional descriptor. After the SIFT keypoints and descriptors are generated, they are stored in a SIFT database which is used for the matching process.

The extracted features are matched against the downloaded local database and confidence levels are generated per query descriptor (410) as discussed below. The confidence level for each descriptor can be a function of the posterior probability, distance ratios, distances, or some combination thereof. Outliers are then removed (420) using the confidence levels, with the remaining objects considered a match to the query image as discussed below. The outlier removal may include geometric filtering in which the geometry transformation between the query image and the reference matching image may be determined. The result may be used to render a user interface, e.g., render 3D game characters/actions on the input image or augment the input image on a display, using the metadata for the object that is determined to be matching (430).

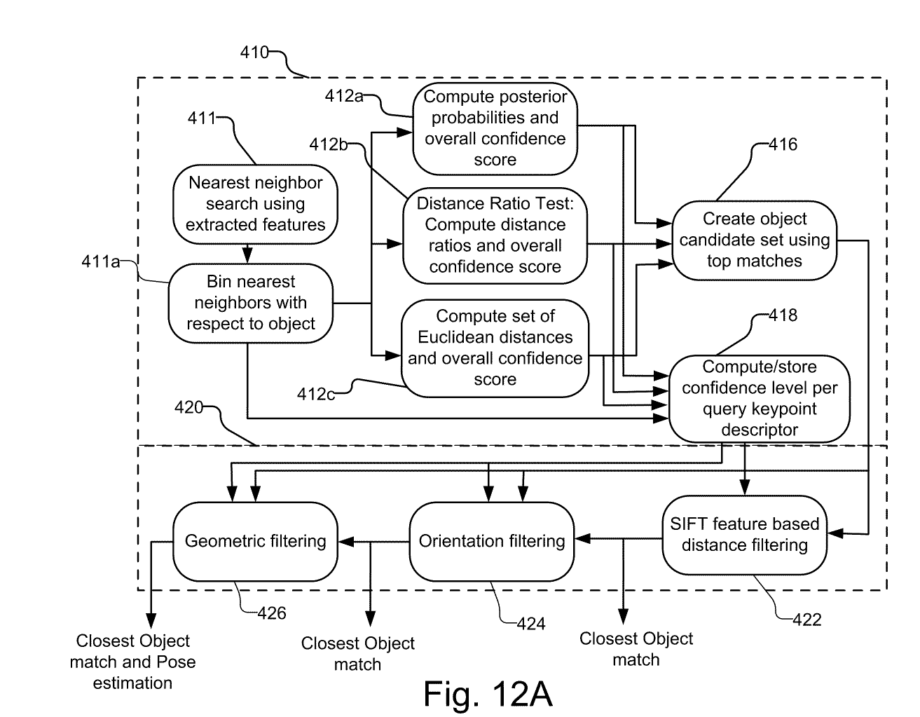

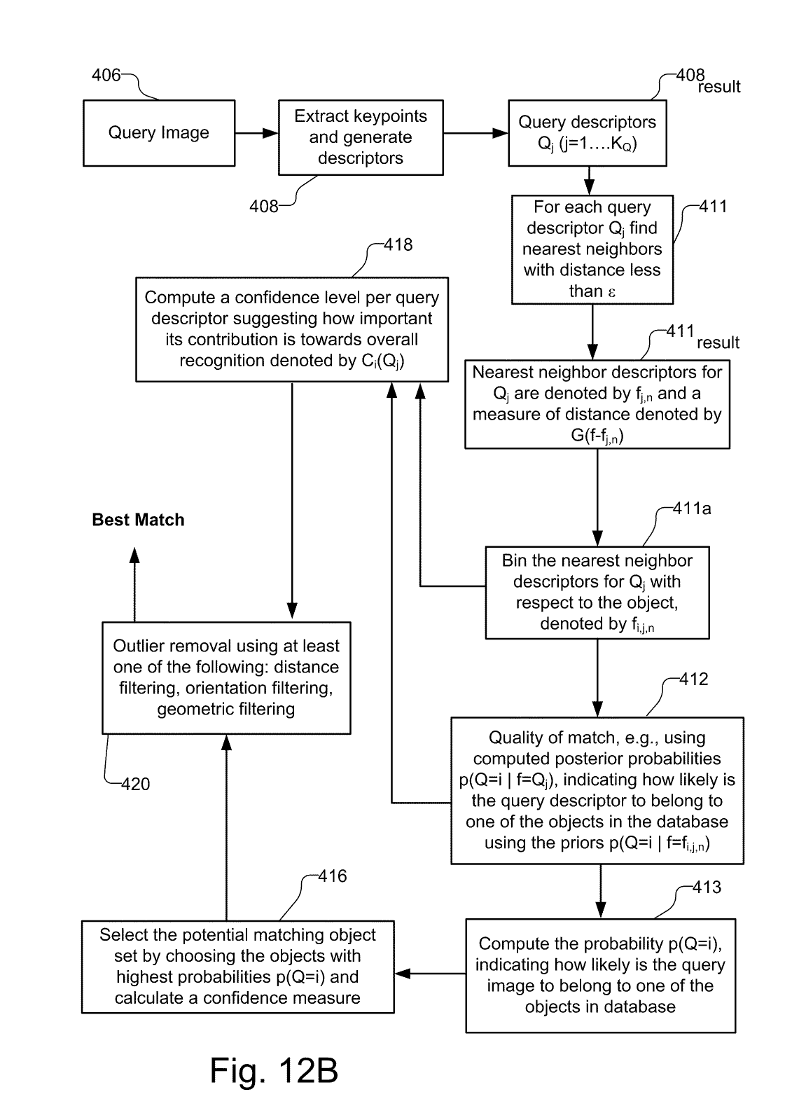

FIGS. 12A and 12B are, respectively, a block diagram and corresponding flow chart illustrating the query process with extracted feature matching and confidence level generation (410) and outlier removal (420). The query image is retrieved (406) and keypoints are extracted and descriptors are generated (408) producing a set of query descriptors Qⱼ (j=1 . . . K_{Q}) (408ᵣₑₛᵤₗₜ). For each query descriptor Qⱼ, a nearest neighbor search is performed using the local database of keypoint descriptors (411). The nearest neighbors may be retrieved using a search tree, e.g., using Fast Library for Approximate Nearest Neighbor (FLANN). For each query image descriptor Qⱼ(j=1 . . . K_{Q}, N nearest neighbors with L₂ distance less than a predetermined threshold distances are retrieved. Alternatively, a distance ratio test may be used to identify nearest neighbors based on Euclidean distance between the d-dimensional SIFT descriptors (d=128 for traditional SIFT). The distance ratio measure is given by the ratio of the distance of the query descriptor with the closest nearest neighbor to the distance of the same with the second closest neighbor. For each query descriptor, the computed distance ratio is then compared to a predetermined threshold thus resulting in the decision whether the corresponding descriptor match is valid or not. The nearest neighbors descriptors for Qⱼ may be denoted by f_{j,n} and a measure of the distance associated with the nearest neighbor may be denoted by G(f-f_{j, n}), wherein n is the nearest neighbor index and G is a Gaussian kernel in the current implementation (411ᵣₑₛᵤₗₜ), but other functions may be used if desired. Thus, the nearest neighbors and a measure of the distances are provided.

The nearest neighbor descriptors for Qⱼ are binned with respect to the object identification, e.g., denoted by f_{i,n}, where i is the object identification and n is the nearest neighbor index (411a). The resulting nearest neighbors and distance measures binned with respect to the object are provided to a confidence level calculation block (418) as well as to determine the quality of the match (412), which may be determined using a posterior probability (412a), distance ratios (412b), or distances (412c) as illustrated in FIG. 12A, or some combination thereof. The computed posterior probabilities p [symbol] (Q=i|f=Qⱼ [symbol] , where i=1 . . . M, indicate how likely is the query descriptor to belong to one of the objects in the database, using the priors p [symbol] Q=i|f=f_{i,n} [symbol] generated during the database building, as follows:

$$p 〈 Q = i \vert f = {Q}_{j} 〉 = {\sum }_{n : {nearest}_{{neighbor}_{index}}} p 〈 Q = i \vert {f}_{i , n} 〉 G [ f - {f}_{i , n} ] . \qquad eq . 6$$

The resulting posterior probability is provided to the confidence level calculation block (418) as well as to compute the probability p(Q=i) (413) indicating how likely is the query image to belong to one of the objects in the database as follows:

$$p ( Q = i ) = \frac{1}{{K}_{Q}} {\sum }_{j = 1}^{{K}_{Q}} p 〈 Q = i \vert f = {Q}_{j} 〉 . \qquad eq . 7$$

The probability p(Q=i) is provided to create the object candidate set (416). The posterior probability p [symbol] Q=i|f=f_{i,n} [symbol] can also be used in a client feedback process to provide useful information that can improve pruning.

Additionally, instead of using the posterior probability (412a), the quality of the match between the retrieved nearest neighbors and the query keypoint descriptors may be performed based on a distance ratio test (412b). The distance ratio test is performed by identifying two nearest neighbors based on Euclidean distance between the d-dimensional SIFT descriptors (d=128 for traditional SIFT). The ratio of distances of the query keypoint to the closest neighbor and the next closest neighbor is then computed and a match is established if the distance ratio is less than a pre-selected threshold. A randomized kd-tree, or any such search tree method, may be used to perform the nearest neighbor search. At the end of this step, a list of pairs of reference object and input image keypoints (and their descriptors) are identified and provided. It is noted that the distance ratio test will have a certain false alarm rate given the choice of threshold. For example, for one specific image, a threshold equal to 0.8 resulted in a 4% false alarm rate. Reducing the threshold allows reduction of the false alarm rate but results in fewer descriptor matches and reduces confidence in declaring a potential object match. The confidence level (418) may be computed based on distance ratios, e.g., by generating numbers between 0 (worst) to 100 (best) depending upon the distance ratio, for example, using a one-to-one mapping function, where a confidence level of 0 would correspond to distance ratio close to 1, and a confidence level of 100 would correspond to distance ratio close to 0.

The quality of the match (412) between the retrieved nearest neighbors and the query keypoint descriptors may also be determined based on distance (412c). The distance test is performed, e.g., by identifying the Euclidean distance between keypoint descriptors from the query image and the reference database, where any two keypoint descriptors f_{i,l} and f_{i,m} (where l, m=1 . . . K) are determined to be a match if the Euclidean distance between the features is less than a threshold, i.e., |f_{i,l}-f_{i,m}∥_{L}_{₂}<τ. The confidence level may be computed (418) in a manner similar to that described above.

The potential matching object set is selected (416) from the top matches, i.e., the objects with the highest probability p(Q=i). Additionally, a confidence measure can be calculated based on the probabilities, for example, using entropy which is given by:

$$Confidence = 1 + \frac{1}{{log}_{2} M} {\sum }_{i = 1 … M} p ( Q = i ) {log}_{2} p ( Q = i ) . \qquad eq . 8$$

The object candidate set and confidence measure is used in the outlier removal (420). If the confidence score from equation 8 is less than a pre-determined threshold, then the query object can be presumed to belong to new or unseen content category, which can be used to a client feedback process for incremental learning stage, discussed below. Note that in the above example, the confidence score is defined based on the classification accuracy, but it could also be a function of other quality metrics.

A confidence level computation (418) for each query descriptor is performed using the binned nearest neighbors and distance measures from (411a) and, e.g., the posterior probabilities from (412a). The confidence level computation indicates the importance of the contribution of each query descriptor towards overall recognition. The confidence level may be denoted by Cᵢ(Qᵢ), where Cᵢ(Qⱼ) is a function of p [symbol] (Q=i|f=Qⱼ [symbol] and distances with nearest neighbors f_{i,n}. The probabilities p [symbol] (Q=i|f=Qⱼ [symbol] may be generalized by considering i as a two-tuple with the first element representing the object identification and the second element representing the view identification.

To refine the candidate set from (416), an outlier removal process is used (420). The outlier removal 420 receives the top candidates from the created candidate set (416) as well as the stored confidence level for each query keypoint descriptor Cᵢ(Qⱼ), which is used to initialize the outlier removal steps, i.e., by providing a weight to the query descriptors that are more important in the object recognition task. The confidence level can be used to initialize RANSAC based geometry estimation with the keypoints that matched well or contributed well in the recognition so far. The outlier removal process (420) may include distance filtering (422), orientation filtering (424), or geometric filtering (426) or any combination thereof. Distance filtering (422) includes identifying the number of keypoint matches between the query and database image for each object candidate and of its views in the candidate set. The distance filtering (422) may be influenced by the confidence levels determined in (418). The object-view combinations with the maximum number of matches may then be chosen for further processing, e.g., by orientation filtering (424) or geometric filtering (426), or the best match may be provided as the closest object match.

Orientation filtering (424) computes the histogram of the descriptor orientation difference between the query image and the candidate object-view combination in the database and finds the object-view combinations with a large number of inliers that fall within <θ₀ degrees. By way of example, θ₀ is a suitably chosen threshold, such as 100 degrees. The object-view combinations within the threshold may then be chosen for further processing, e.g., by distance filtering (422), e.g., if orientation filtering is performed first, or by geometric filtering (426). Alternatively, the object-view combination within a suitably tight threshold may be provided as the closest object match.

Geometric filtering (426) is used to verify affinity and/or estimate homography. During geometric filtering, a transformation model is fit between the matching keypoint spatial coordinates in the query image and the potential matching images from the database. An affine model may be fit, which incorporates transformations such as translation, scaling, shearing, and rotation. A homography based model may also be fit, where homography defines the mapping between two perspectives of the same object and preserves co-linearity of points. In order to estimate the affine and the homography models, RANdom SAmpling Consensus (RANSAC) optimization approach may be used. For example, the RANSAC method is used to fit an affine model to the list of pairs of keypoints that pass the distance ratio test. The set of inliers that pass the affine test may be used to compute the homography and estimate the pose of the query object with respect to a chosen reference database image. If a sufficient number of inliers match from the affinity model and/or homography model, the object is provided as the closest object match. If desired, the geometric transformation model may be used as input to a tracking and augmentation block (430, shown in FIG. 11), e.g., to render 3D-objects on the input image. Once a list of object candidates that are likely matches for a query is determined, a geometric consistency check is performed between each view of the object in the list and the query image. The locations of the matching keypoints retained within the specific object view and the locations of the matching keypoints that were removed (during pruning) within the specific object view may be used for geometry estimation.

FIG. 13 is a block diagram of the mobile platform 100 that is capable of capturing images of objects that are identified by comparison to information related to objects and their views in a database. The mobile platform 100 may be used for navigation based on, e.g., determining its latitude and longitude using signals from a satellite positioning system (SPS), which includes satellite vehicles 102, or any other appropriate source for determining position including cellular towers 104 or wireless communication access points 106. The mobile platform 100 may also include orientation sensors 130, such as a digital compass, accelerometers or gyroscopes, that can be used to determine the orientation of the mobile platform 100.

The mobile platform includes a means for capturing an image, such as camera 120, which may produce still or moving images that are displayed by the mobile platform 100. The mobile platform 100 may also include a means for determining the direction that the viewer is facing, such as orientation sensors 130, e.g., a tilt corrected compass including a magnetometer, accelerometers and/or gyroscopes.

Mobile platform 100 may include a receiver 140 that includes a satellite positioning system (SPS) receiver that receives signals from SPS satellite vehicles 102 (FIG. 1) via an antenna 144. Mobile platform 100 may also includes a means for downloading a portion of a database to be stored in local database 153, such as a wireless transceiver 145, which may be, e.g., a cellular modem or a wireless network radio receiver/transmitter that is capable of sending and receiving communications to and from a cellular tower 104 or from a wireless communication access point 106, respectively, via antenna 144 (or a separate antenna) to access server 210 view network 202 (shown in FIG. 2). If desired, the mobile platform 100 may include separate transceivers that serve as the cellular modem and the wireless network radio receiver/transmitter. Alternatively, if the mobile platform 100 does not perform the object detection, and the object detection is performed on a server, the wireless transceiver 145 may be used to transmit the captured image or extracted features from the captured image to the server.

The orientation sensors 130, camera 120, SPS receiver 140, and wireless transceiver 145 are connected to and communicate with a mobile platform control 150. The mobile platform control 150 accepts and processes data from the orientation sensors 130, camera 120, SPS receiver 140, and wireless transceiver 145 and controls the operation of the devices. The mobile platform control 150 may be provided by a processor 152 and associated memory 154, hardware 156, software 158, and firmware 157. The mobile platform control 150 may also include a means for generating an augmentation overlay for a camera view image such as an image processing engine 155, which is illustrated separately from processor 152 for clarity, but may be within the processor 152. The image processing engine 155 determines the shape, position and orientation of the augmentation overlays that are displayed over the captured image. It will be understood as used herein that the processor 152 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The mobile platform 100 also includes a user interface 110 that is in communication with the mobile platform control 150, e.g., the mobile platform control 150 accepts data and controls the user interface 110. The user interface 110 includes a means for displaying images such as a digital display 112. The display 112 may further display control menus and positional information. The user interface 110 further includes a keypad 114 or other input device through which the user can input information into the mobile platform 100. In one embodiment, the keypad 114 may be integrated into the display 112, such as a touch screen display. The user interface 110 may also include, e.g., a microphone and speaker, e.g., when the mobile platform 100 is a cellular telephone. Additionally, the orientation sensors 130 may be used as the user interface by detecting user commands in the form of gestures.

The methodologies described herein may be implemented by various means depending upon the application. For example, these methodologies may be implemented in hardware 156, firmware 157, software 158, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 154 and executed by the processor 152. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

For example, software 158 codes may be stored in memory 154 and executed by the processor 152 and may be used to run the processor and to control the operation of the mobile platform 100 as described herein. A program code stored in a computer-readable medium, such as memory 154, may include program code to perform a search of a database using extracted keypoint descriptors from a query image to retrieve neighbors; program code to determine the quality of match for each retrieved neighbor with respect to associated keypoint descriptor from the query image; program code to use the determined quality of match for each retrieved neighbor to generate an object candidate set; program code to remove outliers from the object candidate set using the determined quality of match for each retrieved neighbor to provide the at least one best match; and program code to store the at least one best match.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

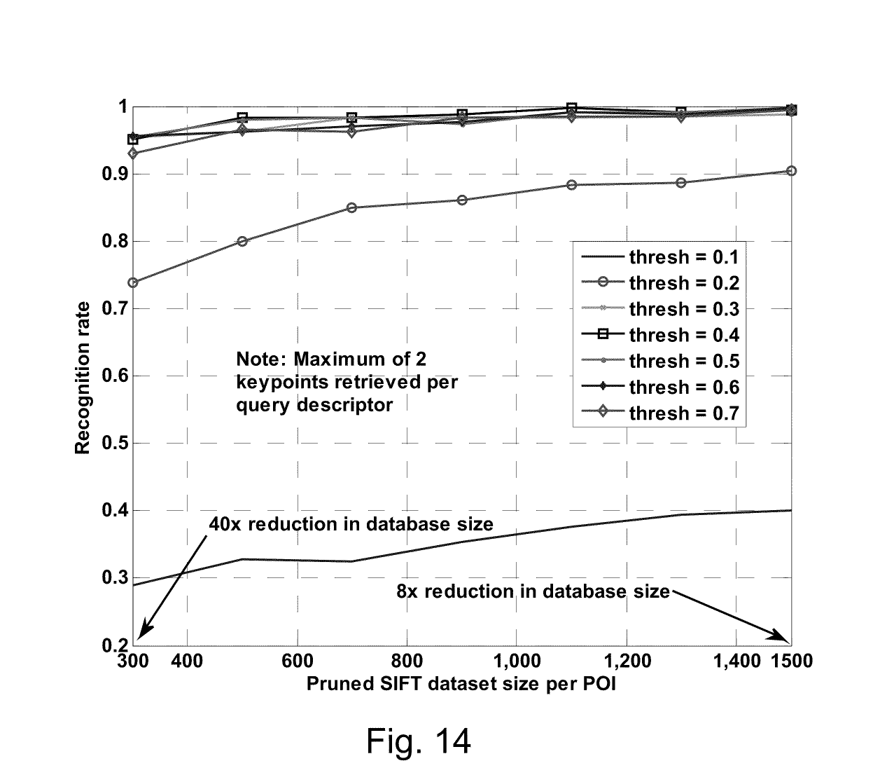

FIG. 14 is a graph illustrating the recognition rate for the ZuBud query images, where the number of objects in the database is 201, and number of image views (each of VGA size) per object is 5. The number of query images (each of half VGA size) provided in ZuBud database is 115. The recognition rate is defined as the ratio of number of true positives to the number of query images. The data from FIG. 14 was obtained with the above-described querying approach and using an information-optimal pruned database. To obtain the data in FIG. 14, the distance threshold for intra-object pruning and inter-object pruning was fixed at 0.4. The number of clusters (k_{c} per database image view was set to 20, and the number of keypoints (kₗ) to be selected per cluster was varied from 3 to 15. From each cluster, the most informative descriptors were identified by ordering them with respect to their conditional entropy described above, and then kₗ keypoints with top scales were selected. Accordingly, the pruned database size per object (POI) is varied from 300 to 1500. The average number of descriptors for each object (combining all the views) in the database is roughly 12,500. Therefore, with the disclosed pruning approach, the database reduction achieved is in a range between 8× to 40×.

The different curves in FIG. 14 correspond to different values for the distance threshold used in step 412c in the querying process. As can be seen, the recognition rate improves with the pruned database size. Additionally, as can be seen, the performance improves with increasing the distance threshold in the query process. However, as the distance threshold increases beyond 0.4, a slight degradation in the performance because noisy matches are retrieved with the higher distance threshold corrupting the probability estimate in equations 6 and 7. With the distance threshold equal to 0.4, the recognition rate achieved is 95% with 40× reduction in database size and 100% with an 8× reduction in database size. These results are better than the existing work from, e.g., G. Fritz, C. Seifert, and L. Paletta, “A Mobile Vision System for Urban Detection with Informative Local Descriptors,” in ICVS '06: Proceedings of the Fourth IEEE International Conference on Computer Vision Systems, 2006, where the authors report a 91% recognition rate based on their pruning approach.

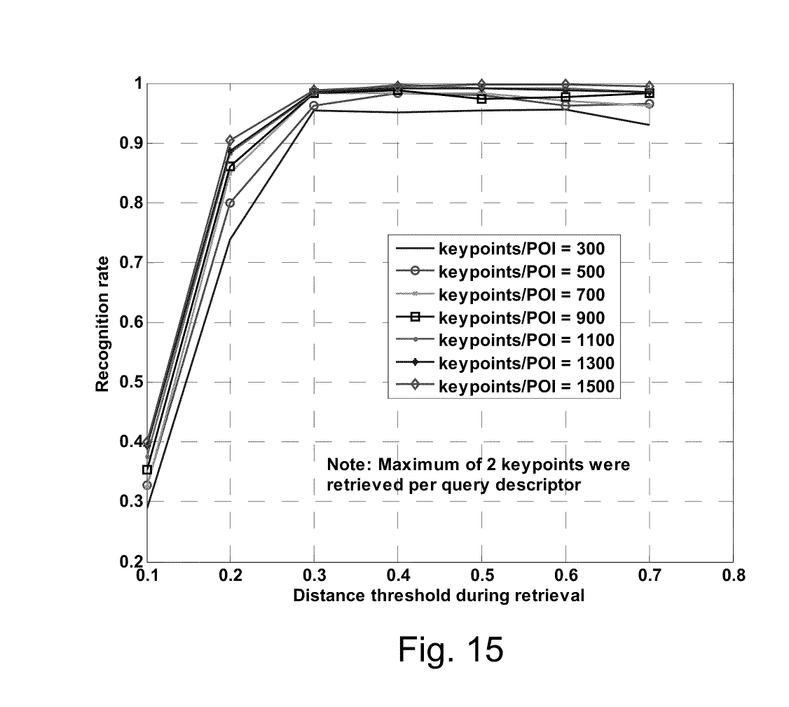

FIG. 15 is a graph illustrating the recognition rate with respect to the distance threshold used for retrieval in FIG. 14. The different curves represent different database sizes after pruning. For a database size of 300 keypoints per POI object (i.e., 40× reduction), the recognition rate starts rolling over as the distance threshold is increased beyond 0.4, as discussed above.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method of building a database for information of objects and images of the objects, the method comprising:
extracting keypoints and generating keypoint descriptors in a plurality of images of a plurality of objects;
performing intra-object pruning for at least one object, the intra-object pruning comprising:
identifying a set of matching keypoint descriptors for a plurality of keypoint descriptors in each image of the at least one object;
removing one or more of the matching keypoint descriptors within each set of matching keypoint descriptors, wherein subsequent to the removal of the one or more of the matching keypoint descriptors there is at least one remaining keypoint descriptor in each set of matching keypoint descriptors;
performing inter-object pruning for a plurality of objects, the inter-object pruning comprising:
characterizing discriminability of the remaining keypoint descriptors;
removing remaining keypoint descriptors with discriminability based on a threshold;
clustering keypoints in each image based on location and retaining a subset of keypoints in each cluster of keypoints;
associating remaining keypoints with an object identifier; and
storing the associated remaining keypoints and object identifier.

2. The method of claim 1, wherein identifying a set of matching keypoint descriptors comprises:
comparing each keypoint descriptor to a plurality of keypoint descriptors from each image of the same object to find a match between keypoint descriptors;
comparing each match between keypoint descriptors to a second threshold and placing keypoint descriptors in a set of matching keypoint descriptors based on the comparison to the second threshold.

3. The method of claim 1, wherein the intra-object pruning further comprises determining and assigning a significance for the remaining keypoint descriptors in each set of matching keypoint descriptors and wherein characterizing discriminability of the remaining keypoint descriptors is based on the assigned significance.

4. The method of claim 3, wherein weight is used to assign the significance for the remaining keypoint descriptors.

5. The method of claim 3, wherein the significance for the remaining keypoint descriptors is determined based on the number of keypoint descriptors in the set of matching keypoint descriptors before removing the one or more of the matching keypoint descriptors.

6. The method of claim 1, further comprising compressing the keypoint descriptors.

7. The method of claim 1, further comprising pruning keypoints in each image based on location by identifying keypoints having a same location and removing one or more keypoints having the same location, wherein subsequent to the removal of the one or more keypoints having the same location there is at least one remaining keypoint for the same location.

8. The method of claim 7, wherein pruning keypoints in each image based on location comprises retaining keypoint with a largest scale for each location.

9. The method of claim 1, wherein clustering keypoints in each image is performed before performing the intra-object pruning.

10. The method of claim 1, wherein clustering keypoints in each image is performed after performing the inter-object pruning.

11. The method of claim 1, wherein removing one or more of the matching keypoint descriptors within each set of matching keypoint descriptors comprises retaining at least one of the matching keypoint descriptors and removing the remaining keypoint descriptors.

12. The method of claim 1, wherein removing one or more of the matching keypoint descriptors within each set of matching keypoint descriptors comprises compounding the matching keypoint descriptors into the remaining keypoint descriptor and removing all of the matching keypoint descriptors.

13. The method of claim 1, wherein removing one or more of the matching keypoint descriptors within each set of matching keypoint descriptors comprises retaining at least one of the keypoint location, scale information, object and view association for each of the removed matching keypoint descriptors.

14. The method of claim 1, wherein characterizing discriminability of the remaining keypoint descriptors comprises:
quantifying a probability for each remaining keypoint descriptor of belonging to any of the plurality of objects; and
determining an entropy measure using the quantified probability for each remaining keypoint descriptor to determine discriminability measure, wherein the determined entropy measure is compared to a second threshold.

15. The method of claim 1, wherein characterizing discriminability of the remaining keypoint descriptors comprises determining a distance between remaining keypoint descriptors that do not belong to the same object, wherein the determined distance is compared to a second threshold.

16. The method of claim 1, wherein clustering keypoints in each image comprises retaining the subset of keypoints with largest scales in each cluster of keypoints.

17. A method of building a database for information of objects and images of the objects, the method comprising:
extracting keypoints and generating keypoint descriptors in a plurality of images of a plurality of objects;
performing inter-object pruning for a plurality of objects, the inter-object pruning comprising:
characterizing discriminability of the keypoint descriptors;
removing keypoint descriptors with discriminability based on a threshold;
clustering keypoints in each image based on location and retaining a subset of keypoints in each cluster of keypoints;
associating keypoints with an object identifier; and
storing the associated keypoints and object identifier.

18. A method of building a database for information of objects and images of the objects, the method comprising:
extracting keypoints and generating keypoint descriptors in a plurality of images of a plurality of objects;
performing intra-object pruning for at least one object, the intra-object pruning comprising:
identifying a set of matching keypoint descriptors for a plurality of keypoint descriptors in each image of the at least one object;
removing one or more of the matching keypoint descriptors within each set of matching keypoint descriptors, wherein subsequent to the removal of the one or more of the matching keypoint descriptors there is at least one remaining keypoint descriptor in each set of matching keypoint descriptors;
clustering keypoints in each image based on location and retaining a subset of keypoints based on scale in each cluster of keypoints;
associating remaining keypoints with an object identifier; and
storing the associated remaining keypoints and object identifier.

19. An apparatus comprising:
an external interface for receiving a plurality of images to be processed and stored in a database, the plurality of images containing a plurality of views of a plurality of objects;
a processor connected to the external interface;
memory connected to the processor; and
software held in the memory and run in the processor to extract keypoints and generate keypoint descriptors in the plurality of images, to perform intra-object pruning for at least one object, the intra-object pruning comprising:
identifying a set of matching keypoint descriptors for a plurality of keypoint descriptors in each image of the at least one object;
removing one or more of the matching keypoint descriptors within each set of matching keypoint descriptors, wherein subsequent to the removal of the one or more of the matching keypoint descriptors there is at least one remaining keypoint descriptor in each set of matching keypoint descriptors;
to perform inter-object pruning for a plurality of objects, the inter-object pruning comprising:
characterizing discriminability of the remaining keypoint descriptors;
removing remaining keypoint descriptors with discriminability based on a threshold;
to cluster keypoints in each image based on location and retain a subset of keypoints in each cluster of keypoints, to associate remaining keypoints with an object identifier; and to store the associated remaining keypoints and object identifier in the database.

20. A system comprising:
means for receiving a plurality of images to be processed and stored in a database, the plurality of images containing a plurality of views of a plurality of objects;
means for extracting keypoints and generating keypoint descriptors in the plurality of images;
means for performing intra-object pruning comprising:
identifying a set of matching keypoint descriptors for a plurality of keypoint descriptors in each image of the plurality of objects;
removing one or more of the matching keypoint descriptors within each set of matching keypoint descriptors, wherein subsequent to the removal of the one or more of the matching keypoint descriptors there is at least one remaining keypoint descriptor in each set of matching keypoint descriptors;
means for performing inter-object pruning for a plurality of objects, the inter-object pruning comprising:
characterizing discriminability of the remaining keypoint descriptors;
removing remaining keypoint descriptors with discriminability based on a threshold;
means for clustering keypoints in each image based on location and retaining a subset of keypoints in each cluster of keypoints;
means for associating remaining keypoints with an object identifier; and
means for storing the associated remaining keypoints and object identifier in the database.

21. A computer-readable medium including program code stored thereon, comprising:
program code to extract keypoints and generate keypoint descriptors from a plurality of images;
program code to perform intra-object pruning including identifying a set of matching keypoint descriptors for a plurality of keypoint descriptors in each image of each object and removing one or more of the matching keypoint descriptors within each set of matching keypoint descriptors, wherein subsequent to the removal of the one or more of the matching keypoint descriptors there is at least one remaining keypoint descriptor in each set of matching keypoint descriptors;
program code to perform inter-object pruning for a plurality of objects in the plurality of images including characterizing discriminability of the remaining keypoint descriptors and removing remaining keypoint descriptors with discriminability based on a threshold;
program code to cluster keypoints in each image based on location and retain a subset of keypoints in each cluster of keypoints;
program code to associate remaining keypoints with an object identifier; and
program code to store the associated remaining keypoints and object identifier in a database.

22. A method of determining at least one best match between a query image and information related to images of objects in a database using extracted keypoint descriptors from the query image and keypoint descriptors in the database, the method comprising:
performing a search of the database using the keypoint descriptors from the query image to retrieve neighbors;
determining a quality of match for each retrieved neighbor with respect to associated keypoint descriptor from the query image;
using the determined quality of match for each retrieved neighbor to generate an object candidate set;
removing outliers from the object candidate set using the determined quality of match for each retrieved neighbor to provide the at least one best match; and
storing the at least one best match.

23. The method of claim 22, wherein the at least one best match is one of a best object match and a best view match.

24. The method of claim 22, wherein removing outliers from the object candidate set comprises filtering the object candidate set based on keypoint descriptor distance between the keypoint descriptors for the query image and keypoint descriptors of objects in the object candidate set.

25. The method of claim 24, wherein filtering the object candidate set comprises:
determining a number of keypoint descriptor matches for each object in each view in the object candidate set by identifying the number of keypoint descriptors of the object in the object candidate set that is less than a threshold distance from the keypoint descriptors from the query image; and
retaining a subset of objects in the object candidate set with a greatest number of keypoint descriptor matches.

26. The method of claim 22, wherein removing outliers from the object candidate set comprises filtering the object candidate set based on orientation.

27. The method of claim 26, wherein filtering the object candidate set based on orientation comprises:
determining keypoint descriptor orientation differences between keypoint descriptors from the query image and keypoint descriptors for each object;
computing a histogram of the keypoint descriptor orientation difference; and
retaining objects in the object candidate set having a subset of inliers that are within a threshold keypoint descriptor orientation difference.

28. The method of claim 22, wherein removing outliers from the object candidate set comprises filtering the object candidate set based on geometry, wherein a pose estimation of the object in the query image is provided.

29. The method of claim 28, wherein filtering the object candidate set based on geometry comprises fitting an affine model to matching keypoints descriptors pairs from the query image and objects in the object candidate set to determine a set of inliers of each object.

30. The method of claim 28, wherein filtering the object candidate set based on geometry comprises computing a homography and estimate a pose of the query image with respect to the object image.

31. The method of claim 22, wherein performing a search of an object database comprises:
determining a distance between the keypoint descriptors from the query image and keypoint descriptors from objects in the object database;
comparing the determined distance to a threshold;
storing keypoint descriptors and an associated object identification as nearest neighbors when the determined distance is less than the threshold.

32. The method of claim 22, wherein performing a search of an object database comprises:
determining a distance between the keypoint descriptors from the query image and keypoint descriptors from objects in the object database to determine a closest neighbor and next closest neighbor;
computing a ratio of a distance between the closest neighbor and the next closest neighbor for each keypoint descriptor from the query image; and
comparing the ratio to a threshold.

33. The method of claim 22, wherein determining the quality of match for each retrieved neighbor with respect to associated keypoint descriptor from the query image comprises at least one of computing posterior probabilities, computing distance ratios of distances between keypoint descriptors from the query image and retrieved neighbors and distances between two retrieved neighbors, and determining distances between keypoint descriptors from the query image and the retrieved neighbors.

34. The method of claim 33, wherein computing posterior probabilities comprises quantifying the probability for each query descriptor of belonging to any of a plurality of objects.

35. The method of claim 22, wherein the database contains keypoint descriptors with different weights for a plurality of objects and determining the quality of the match uses the weights of the keypoint descriptors.

36. The method of claim 22, wherein determining the quality of the match comprises computing confidence scores by determining entropy measures for the retrieved neighbors.

37. A mobile platform comprising:
a camera for capturing a query image;
a database of information with respect to reference objects and their images;
a processor connected to receive the query image;
memory connected to the processor;
a display connected to the memory; and
software held in the memory and run in the processor to extract keypoints and generate descriptors from the query image, to perform a search of the database using the keypoint descriptors from the query image to retrieve neighbors; to determine a quality of match for each retrieved neighbor with respect to associated keypoint descriptor from the query image; to use the determined quality of match for each retrieved neighbor to generate an object candidate set; to remove outliers from the object candidate set using the determined quality of match for each retrieved neighbor to provide at least one best match, and to store the at least one best match.

38. A system for determining at least one best match between a query image and information related to images of objects in a database using extracted keypoint descriptors from the query image and keypoint descriptors in the database, the system comprising:
means for performing a search of the database using the keypoint descriptors from the query image to retrieve neighbors;
means for determining a quality of match for each retrieved neighbor with respect to associated keypoint descriptor from the query image;
means for using the determined quality of match for each retrieved neighbor to generate an object candidate set;
means for removing outliers from the object candidate set using the determined quality of match for each retrieved neighbor to provide the at least one best match; and
means for storing the at least one best match.

39. A computer-readable medium including program code stored thereon, comprising:
program code to perform a search of a database using extracted keypoint descriptors from a query image to retrieve neighbors;
program code to determine a quality of match for each retrieved neighbor with respect to associated keypoint descriptor from the query image;
program code to use the determined quality of match for each retrieved neighbor to generate an object candidate set;
program code to remove outliers from the object candidate set using the determined quality of match for each retrieved neighbor to provide at least one best match; and
program code to store the at least one best match.
